(19) United States
(12) Patent Application Publication
(10) Pub. No.: US 2015/0118370 A1
(43) Pub. Date: Apr. 30, 2015

(54) MICROWAVE MACARONI COOKING BOWL

(71) Applicant: Christopher Johnson, Wilton, CA (US)

(72) Inventor: Christopher Johnson, Wilton, CA (US)

(21) Appl. No.: 14/525,570

(22) Filed: Oct. 28, 2014

Related U.S. Application Data
(60) Provisional application No. 61/898,196, filed on Oct. 31, 2013.

(51) Int. Cl. A47J 36/02; A23L 1/01; A23L 1/162

(52) U.S. Cl. CPC A47J 36/027; A23L 1/162; A23L 1/0128; A23V 2002/00
USPC 426/243; 219/725

(57) ABSTRACT

A bowl is provided for cooking pasta in a microwave in a simple high quality fashion. The bowl includes a reservoir with a floor and at least one wall extending up from the floor to a rim. Handles optionally extend laterally from opposite sides of the rim in a generally horizontal direction. A water line is provided on the at least one wall which is visible to a user. An optional pasta line is also provided beneath the water line. Pasta is provided from a package of pasta and flavorant with the bowl sized to match the amount of pasta in this package. Water is provided up to the water line. The bowl is then placed within a microwave and heated for a predetermined amount of time, preferably with a pause for stirring during this predetermined amount of time. The flavorant from the package is then added to the pasta.

### CROSS-REFERENCE TO RELATED APPLICATIONS

This application claims benefit under Title 35, United States Code §119(e) of U.S. Provisional Application No. 61/898,196 filed on Oct. 31, 2013.

### FIELD OF THE INVENTION

The following invention relates to cookware for cooking of pasta and similar foods by heating the pasta within a water bath. More particularly, this invention relates to pasta cooking containers which facilitate cooking of pasta in a microwave oven.

### BACKGROUND OF THE INVENTION

Pasta is most typically cooked on a stovetop. This stovetop cooking method involves locating an appropriately sized pan or other container, placing an amount of pasta to be cooked within the pan, adding water into the pan and placing the pan on a cooktop and applying heat until the pasta is cooked. Finally, the excess water is poured off, typically using some form of strainer. While seemingly straightforward, this pasta cooking process has multiple opportunities for serious error.

For instance, it can be difficult to cook the pasta for the proper amount of time. One can watch the pot of pasta being cooked very carefully but it is difficult to see when the pasta is fully cooked. Without tasting or otherwise testing a sample of the pasta, it can be difficult to determine if the pasta has been fully cooked or not. Overcooked pasta is often undesirably “mushy,” while undercooked pasta is too hard. The pan must also be watched to avoid a risk of “boiling over” onto the cooktop. Hence, a cook who is cooking pasta, especially when a novice, must carefully attend to the cooking pan of pasta and cannot easily multi-task with other cooking activities while the pasta is cooking.

Even when pasta is perfectly cooked, before the pasta can be enjoyed, the user typically must drain the pasta of excess water, add a flavorant package (such as cheese when making “macaroni and cheese”) and transfer the pasta to a separate serving appliance, such as plates or bowls. A serving utensil is typically utilized which then must also be later washed. Leftover pasta which was not utilized in the meal must either be disposed of or transferred to a storage container for placement in a refrigerator or otherwise storing for later consumption.

A need is particularly acute for individuals and small groups, and especially those in cooking environments with limited space, to simplify the pasta cooking process to provide quality pasta in a repeatable fashion, and utilizing as little space and as little equipment as possible. Such circumstances might include individuals living in studio apartments or other small locations, or students (and others) in dormitories, or other individuals living in tight quarters or with limited cooking resources. Such small environments almost always include a microwave oven therein such that a need exists to utilize the microwave oven in the cooking of a single serving or a small number of servings of pasta, in a manner which minimizes equipment required and amount of cleanup before the pasta can be effectively enjoyed.

One form of pasta is known as “macaroni and cheese” (although the pasta can be of a type other than macaroni). Such a product is pre-packaged with a predetermined amount of pasta, often in a box, along with a packet containing a cheese powder (or other cheese flavorant). A need exists to simplify cooking of this predetermined amount of pasta and adapting a cooking method to utilize a microwave oven.

### SUMMARY OF THE INVENTION

With this invention a pasta cooking bowl is provided suitable for use in a microwave oven. The bowl doubles as both a cooking bowl and also a bowl from which the pasta can be served or directly enjoyed for consumption. The bowl is configured to function as a measuring device initially for measuring quantities of at least the water to be utilized in a cooking process, and optionally also the water. The bowl then functions as a cooking container for holding the pasta during cooking thereof in a microwave oven. The cooking bowl has a shape which facilitates even and high quality cooking of the pasta in a rapid fashion utilizing the microwave energy supplied by the microwave oven. The cooking bowl also preferably includes handles which are heat resistant, at least due to their geometry, to enable the cooking bowl to be easily removed from the microwave when containing the cooked pasta therein.

The bowl includes a reservoir defined by a floor on a lower surface and with at least one wall extending up from the floor to a rim. This wall could be circular or oval, or could be more square or rectangular or some other geometric shape with sides joining together to surround the reservoir extending up from the floor to the rim. In the embodiments depicted herein, the reservoir has a somewhat rounded square shape with a pair of side walls spaced from each other and a pair of end walls spaced from each other and between two of the side walls. Side walls and end walls transition together through lateral curves which give the reservoir its somewhat rounded square shape. Lower curves are preferably provided transitioning between the floor and the at least one wall. Such curves make it easier for a user to enjoy all of the pasta within the container and to have an easier cleanup process after the bowl has completed its use.

Handles are preferably provided, such as with a pair of handles extending from each end wall adjacent the rim in embodiments such as those depicted herein. The handles preferably extend from the rim to a tip with an arch on an upper surface and a cove on a lower surface. The convex arch on the upper surface keeps hot water from pooling on the handles which might otherwise injure a user. The cove on the lower surface acts as a convenient purchase area for fingers of a user to rest under the handles and easily move the bowl out of the microwave and otherwise move the bowl where desired.

The bowl includes a visible water line thereon and an optional pasta line. The pasta line is visible to a user and defines a level up to which pasta should be placed into the bowl for cooking. When the bowl is used with a predetermined amount of pasta, such as that provided in a box or other package of macaroni and cheese, the pasta line is not strictly necessary. The water line is provided above the pasta line and defines a line up to which water should next be supplied when the pasta is to be cooked. The pasta line and water line are located precisely where desired for optimal cooking of the pasta. The pasta line and water line can be mere visual markings, such as those printed on an inside surface of at least one of the walls. The lines could be geometrically formed into at least one of the walls, such as by providing a step, a groove or a bump at the line location which can be visually perceived by a user.

The at least one wall extends up from the floor to the rim in a direction which is tapered away from perpendicular from the floor by a taper angle away from vertical, and causing the rim to be wider than the floor. A taper angle for this taper is most preferably about 10°, but provides benefit to the invention when at least 5°. This taper helps to contain the water as it boils

The extraordinarily simple method of cooking pasta with the microwave pasta cooking bowl of this invention merely includes filling the reservoir with pasta up to the pasta line (or dumping a predetermined amount of pasta from a package into the reservoir), filling the reservoir with water up to the water line, placing the bowl with pasta and water into the microwave, and operating the microwave for a preferred amount of cooking time. When the time has elapsed (optionally with an intermediate break for stirring), the pasta is ready to enjoy directly from the bowl, typically by adding other ingredients to the pasta directly within the bowl and then enjoying the pasta and other ingredients directly from the bowl, or utilizing the bowl as a serving dish.

### OBJECTS OF THE INVENTION

Accordingly, a primary object of the present invention is to provide a bowl for cooking pasta in a microwave.

Another object of the present invention is to provide a pasta cooking method which is faster than previous methods.

Another object of the present invention is to provide a bowl sized to cook pasta provided in a predetermined amount such as pasta provided in a package of macaroni and cheese.

Another object of the present invention is to provide a pasta cooking bowl which can cook at least one serving of pasta quickly.

Another object of the present invention is to provide a pasta cooking bowl which can both cook pasta and act as a serving container for serving the pasta.

Another object of the present invention is to provide a pasta cooking bowl which cooks pasta in amounts as small as a single serving.

Another object of the present invention is to provide a method for cooking and enjoying pasta which has a minimum of cleanup and requires a minimum amount of cooking space and cooking equipment.

Another object of the present invention is to provide a pasta cooking method which is simple to perform without requiring specialty tools such as measuring cups.

Another object of the present invention is to provide a pasta cooking method which is resistant to problems such as burning the pasta, overcooking the pasta, undercooking the pasta or “soupy” pasta.

Other further objects of the present invention will become apparent from a careful reading of the included drawing figures, the claims and detailed description of the invention.

### BRIEF DESCRIPTION OF THE DRAWINGS

FIG. 1 is a perspective view of the pasta cooking bowl of this invention according to a first embodiment.

FIG. 2 is a top plan view of that which is shown in FIG. 1.

FIG. 3 is an end elevation view of that which is shown in FIG. 1.

FIG. 4 is a front elevation view of that which is shown in FIG. 1.

FIG. 5 is a perspective view of that which is shown in FIG. 1 after a first step of adding pasta to the reservoir of the bowl.

FIG. 6 is a perspective view of that which is shown in FIG. 5 after water has been further added to the bowl.

FIG. 7 is a side elevation full sectional view of that which is shown in FIG. 6.

FIG. 8 is a view similar to FIG. 7 but after the pasta has been cooked and the water absorbed by the pasta.

FIG. 9 is an exploded view of a package including a predetermined amount of pasta and a flavorant packet.

FIG. 10 is a perspective view of the package of FIG. 9 pouring pasta into a single water line variation of the bowl of FIG. 1.

FIG. 11 is a perspective view of the flavorant packet of FIG. 9 being added to the cooked pasta in the bowl of FIG. 10.

### DESCRIPTION OF THE PREFERRED EMBODIMENT

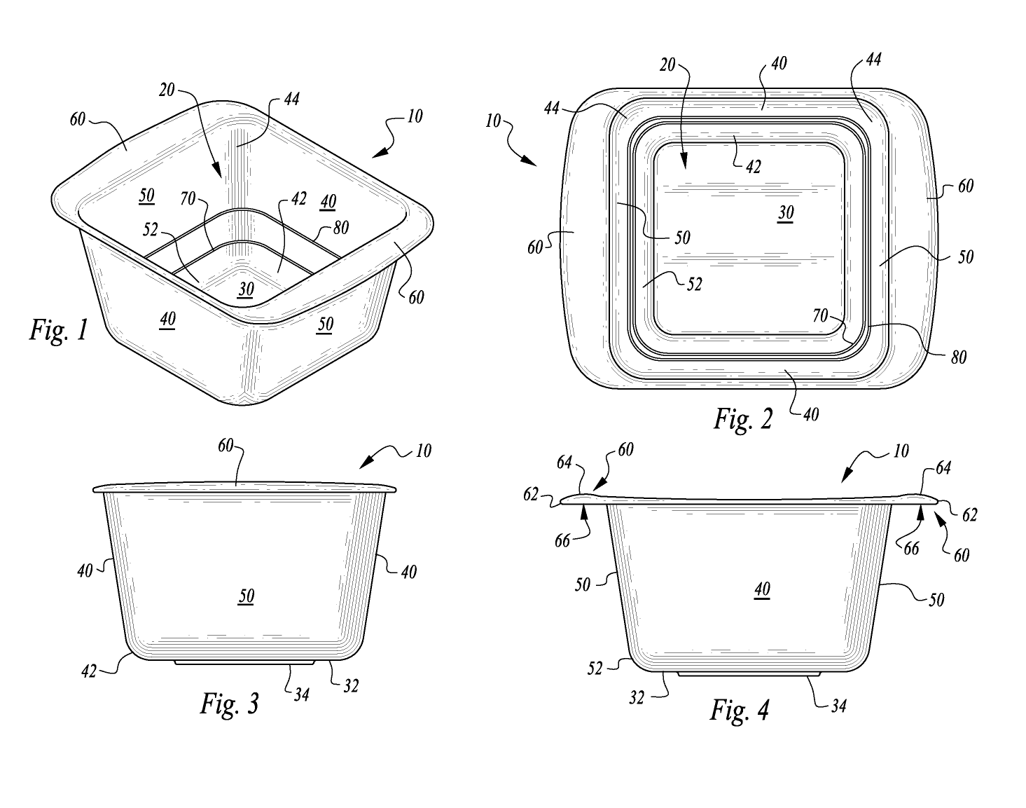

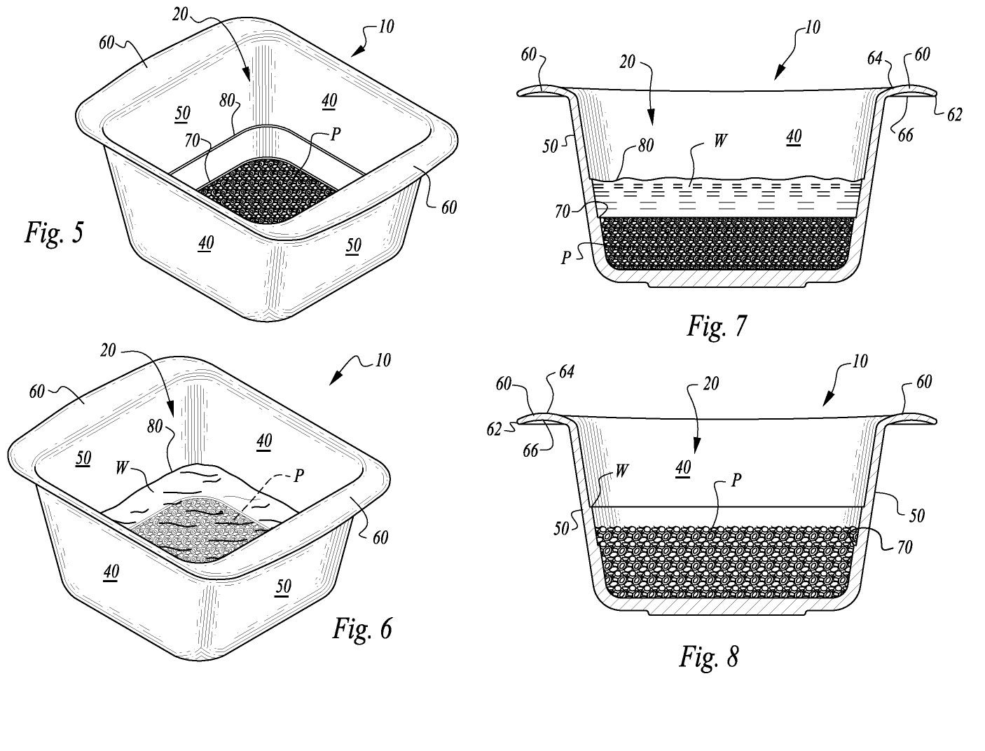

Referring to the drawings, wherein like reference numerals represent like parts throughout the various drawing figures, reference numeral 10 is directed to a bowl (FIG. 1) for cooking of pasta (such as macaroni) for a single serving or small number of servings of a dish, such as macaroni and cheese. The bowl 10 contains the pasta and water for cooking within a microwave and can also contain the pasta and optional flavorant as a serving dish as well.

In essence, and with particular reference to FIGS. 1-4, basic details of the bowl 10 are described, according to a preferred embodiment. The bowl 10 provides an open topped enclosure for supporting the pasta P and water W for cooking. The bowl 10 includes a reservoir 20 defined by a floor 30 at a lower side thereof and at least one wall extending up from the floor 30 to a rim 90. Most preferably, this at least one wall is actually provided as a pair of side walls 40 spaced from each other by a pair of end walls 50. Handles 60 preferably extend laterally from the rim 90 on opposite sides of the reservoir 20, such as from each of the end walls 50. At least one visible line is provided along the at least one wall in the form of a water line 80 parallel with the floor 30. The water line 80 defines a level up to which water should be provided after pasta P has been placed within the reservoir 20. An optional pasta line 70 can be provided to designate a volume of pasta P to be added before the water W, or the pasta volume can be provided in a predetermined amount from a package such as a box 120.

More specifically, and with continuing reference to FIGS. 1-4, details of the reservoir 20 along with the floor 30 and walls 40, 50 are described, according to a first embodiment. The floor 30 is a planar rigid surface configured to be oriented substantially horizontally and defining a lowermost portion of the reservoir 20. The floor 30 can have any of a variety of different perimeter shapes including circular, square, rectangular, oval, or some other preferably substantially two-dimensional geometric shape. The floor 30 could conceivably be somewhat non-planar with a lowermost central portion that most preferably is substantially planar. Any corners of the floor 30 between flat edges are preferably rounded somewhat rather than being pointed.

Most preferably, the floor 30, side walls 40 and end walls 50 are formed together as a unitary mass of rigid injection moldable plastic material. A plastic material is selected which is capable of forming by molding, and which also is resistant to melting, outgassing or other alterations when experiencing the microwave energy present within a microwave oven and when experiencing typical heat ranges associated with boiling of water W and cooking of food within a microwave oven. One such suitable plastic material includes polypropylene. Others include high density polyethylene and polyethylene terephthalate.

While the bowl 10 is preferably formed of an injection moldable plastic material, the bowl 10 could be formed from other materials suitable for the heat and microwave energy environment within a microwave oven, and also suitable for coming into direct contact with food items. Such alternative materials could include glass, ceramics, wood and other cellulosic materials, and various different hydrocarbon solid materials known to exist or developed in the future.

An undersurface 32 of the floor 30 preferably has at least one foot 34 extending downward therefrom which acts as a pedestal to support the floor 30 slightly above a horizontal underlying surface. In the embodiment depicted, the foot 34 is in the form of an annular rib extending downward from the undersurface 32 close to a perimeter edge of the floor 30. The foot 34 could alternatively be a series of discreet elements extending down from the undersurface 32 to support the floor 30 above an underlying horizontal surface. The undersurface 32 is also a convenient location for instructions to be provided. In the embodiment depicted, the floor 30 is substantially square and the foot is in the form of a rounded square circuit extending downward from the undersurface 32 with slightly rounded corners. The floor 30 has an upper surface opposite the undersurface 32 which faces into the reservoir 20. The upper surface of this floor 30 provides a location where instructions can be provided including steps to follow in the preparation of a pasta dish such as macaroni and cheese. A trademark can also be conveniently located on the undersurface 32 or upper surface of the floor 30.

In the embodiment depicted, the at least one wall is provided in the form of a pair of side walls 40 and a pair of end walls 50. In other embodiments a single circular wall could be provided. The end walls 50 and side walls 40 are in this embodiment each similar in width and generally interchangeable, except that the end walls 50 support handles 60 at upper ends thereof. In alternative embodiments the side walls 40 and end walls 50 could have differing dimensions such that the reservoir 20 would be provided as a rectangle. In such embodiments the side walls 40 would typically be wider than the end walls 50 so that the handles 60 would be provided on shorter sides of the reservoir 20.

The side walls 40 and end walls 50 each have lower curves 42, 52 which provide a transition between the floor 30 and the side walls 40. These lower curves 42, 52 preferably have a constant radius of curvature transitioning from horizontal and parallel with the floor to just short of vertical and just short of perpendicular to the floor 30. The resulting side walls 40 and end walls 50 exhibit a taper away from perpendicular to the floor which is beneficially provided to inhibit boiling over of the water W and pasta P during cooking, such as within a microwave.

Through experience it has been determined that a taper angle of 10° away from perpendicular to the floor is optimal for both keeping the pasta P and water W in a compact mass for most even and efficient heating, as well as preventing boiling over of water W. In particular, when water is heated to a boil, and especially when a starch such as pasta is contained within the boiling water, the water W can have a tendency to form bubbles and froth on an upper surface of the boiling water W. The water/steam rises within the reservoir 20 and rises somewhat merely due to the dynamic nature of the boiling process and the rapid tumbling of the surface of the water W. As bubbles/froth form and rise, they have a high probability of boiling over a dish having vertical sides. Because the side walls 40 and end walls 50 exhibit a taper, the rim 90 is wider than the floor 30. Thus, the forces tending to cause this froth of bubbles and water to rise within the bowl is inhibited because a greater surface area must be supported by these rising bubbles/froth a they approach the rim 90.

With a 10° taper angle, this frothing boiling surface has a tendency to rise somewhat toward the rim 90, but to reach a maximum height just short of the rim 90 and to reach equilibrium as the boiling process continues. Thus, boiling over and the associated mess and loss of water is avoided. While a 10° taper angle has been shown to be most optimal, the minimal benefits associated with this taper can be enjoyed when a taper angle of at least 5° is provided. This taper also facilitates the nesting of multiple bowls 10 within each other somewhat for efficient storage when not in use.

The handles 60 preferably extend from the rim 60 in a horizontal direction from each of the end walls 50 or other opposite sides of the rim 90. Each handle 60 extends from a root adjacent the end walls 50 to a tip 62. This tip 62 is preferably a free tip allowing fingers to easily pass under the handles 60. The handles 60 preferably have an arch 64 of convex contour defining an upper surface and a cove 66 having a concave contour defining an undersurface. The arch 64 prevents water from pooling on the handles which can be exceptionally hot and present a risk of burning a user. The cove 66 provides a convenient location into which fingers can be placed to more firmly grip the handles 60 to carry the bowl 10.

The handles 60 also provide the beneficial function of providing a heat resistant location for hands of the user to grasp the bowl 10. In particular, conduction heat transfer can cause material forming the bowl 10 to be quite hot, and often a temperature similar or even greater than a boiling temperature for water (100° C. and 212° F.). Because the handles 60 extend as a thin structure away from the rim 90, and because the rim 90 is somewhat distant from the pasta P and water W which has been heated, the handles 60 are significantly lower in temperature, and typically sufficiently cool that they can be grasped with bare hands. Alternatively, some form of heat resistant structure such as an oven mitt can be utilized if desired. The handles 60 preferably maintain a substantially constant thickness as they extend from the rim 90 out to their tips 62.

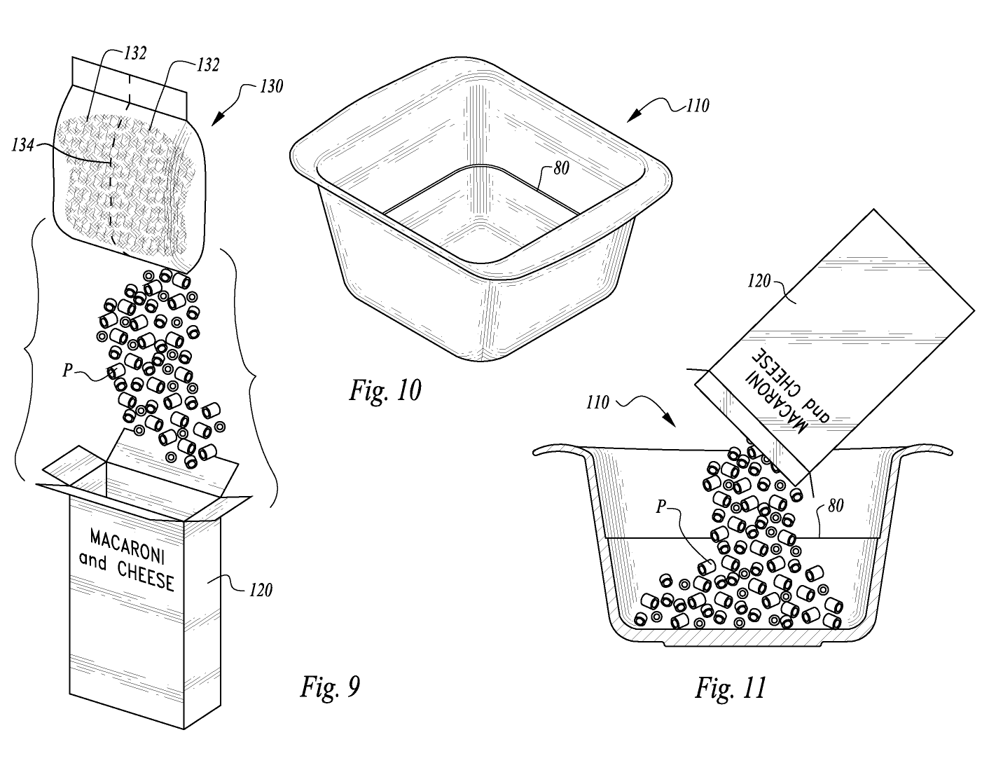

With continuing reference to FIGS. 1-4, details of the water line 80 are described, according to a first embodiment. In other embodiments (FIGS. 9-11), only one line is provided in the form of a water line 80. The water line 80 is located closer to the floor 30 than to the rim 90 and defines a height to which water W should be placed into the reservoir 20 after pasta P has been placed into the reservoir 20. This water line 80 is preferably about 1.125 inches from the floor 30 for optional results, with a distance of about 1.0 inches to 1.25 inches being generally effective. In terms of amount, eleven ounces of water W are preferably placed in the bowl 10. A pasta line 70 defines a volume of pasta P to first place in the reservoir 20. In other embodiments, the bowl 10 is sized to match a size of contents of a pre-packaged pasta and flavoring packet product. As an example (FIG. 9), a macaroni and cheese food product is often provided in a box 120 or other package which includes uncooked pasta and a flavoring packet 130, typically in the form of a powdered cheese flavored substance. Such a box 120 is typically provided with a sufficient amount to provide a certain number of servings, such as two servings of macaroni and cheese or other pasta P. The bowl 10 is sized to work with such a pre-packaged pasta product. For this reason, the amount of pasta P does not need to be measured. Rather, the box 120 or other package is opened and the uncooked pasta P is poured into the reservoir 20. The pasta line 70 is thus optional. This pasta line 70 is preferably about 0.75 inches from the floor 30 for optimal results, with a distance of 0.5 to 1.0 inches also being generally effective. In terms of amount, five ounces of pasta P are preferably placed into the bowl 10.

Water W is then placed in the reservoir 20 up to the water line 80. The bowl 10 is then placed into a microwave oven and heated for a predetermined amount of time. In one embodiment the amount of time for cooking is two and a half minutes followed by a stirring step followed by two more minutes of cooking time. After the second time period of cooking, the flavoring packet 130, such as cheese flavoring, is added and mixed with the pasta P. Other ingredients could also be added, such as butter, margarine, vegetables, sauces having flavors other than cheese, meats and other comestibles. Finally, a user can enjoy the pasta meal. In one embodiment the user would merely utilize a utensil and eat the macaroni and cheese or other pasta dish directly from the bowl 10. In another embodiment, and when the meal is provided for multiple individuals, a serving spoon can be utilized and the macaroni and cheese or other pasta meal can be served from the bowl 10.

In one embodiment a pasta line 70 is provided on the at least one wall extending up from the floor 30. This pasta line 70 can provide a line up to which pasta P should be provided if the bowl 10 is to be utilized with pasta P that has not already been pre-measured to a particular amount, such as by providing it within the pre-packaged box 120 or other container along with a sauce packet. In one embodiment the bowl 10 is sized somewhat smaller than the size for cooking a whole pre-packaged macaroni and cheese or other pasta meal package, and is instead particularly configured to provide a single serving of macaroni and cheese or other pasta. A box or other package of macaroni and cheese or other pasta could still be utilized, but only some (e.g. half if the box contains two servings) of the pasta would be used, filling the reservoir 20 up to the pasta line 70. Water would then be provided up to the water line 80 and heating would occur. Time for cooking might be adjusted slightly for a smaller amount. Unused pasta and/or flavoring package portions could be closed up and utilized later for a later second serving. In this way, a bowl 10 is provided which provides a single serving of macaroni and cheese.

In one embodiment where a pre-packaged pasta and cheese flavorant package provides two servings, the bowl 10 is sized with a pasta line 70 sufficient to utilize exactly half of the pasta within the pre-packaged container. Thus, two servings are still provided in the pre-packaged container, but they are utilized in separate cooking steps utilizing such a bowl 10 sized for a single serving. If desired, a set of bowls 10 could be utilized with a single pre-packaged macaroni and cheese or other pasta and flavorant package, with half of the pasta placed in each of the bowls 10 and water W up to water lines 80, and with a pasta line 70 optionally provided to assist in splitting the amount of pasta in the package. A further enhancement to such a system would involve providing a package 120 of macaroni and cheese or other pasta and flavorant which would have the flavorant package split into two separate packages which are at least partially separate from each other and which compartments 132 (separated by a divider 134) can be opened sequentially or individually, so that either one or two meals can be provided from such a box. Single or double serve macaroni and cheese or other pasta and flavorant options are thus facilitated. A bowl could also be provided with a single serving water line and a double serving water line, and optionally two pasta lines to use the same bowl for one or for two servings.

While this invention is largely described in conjunction with pasta being in the form of macaroni, other forms of pasta could also be utilized with this invention. If the pasta has thicker walls or generally larger pieces, the amount of time for cooking can be increased slightly. The bowl 10 can either be optimized for particular shape and size of pasta or can be provided with multiple different water lines 80 labeled for different sizes of pasta.

This disclosure is provided to reveal a preferred embodiment of the invention and a best mode for practicing the invention. Having thus described the invention in this way, it should be apparent that various different modifications can be made to the preferred embodiment without departing from the scope and spirit of this disclosure. When structures are identified as a means to perform a function, the identification is intended to include all structures which can perform the function specified.

What is claimed is:

1. A microwave pasta cooking bowl, comprising in combination:
a bowl having a reservoir for holding pasta and water during cooking;
said bowl including a floor defining a lower side of said reservoir;
said bowl including at least one wall extending up from said floor to a rim opposite said floor;
a water line formed in said at least one wall, said water line spaced from said floor and visible to a user; and
said reservoir having a volume below said water line equal to a volume of combined water and uncooked pasta sufficient to cook a predetermined amount of pasta.

2. The bowl of claim 1 wherein said at least one side wall includes a continuously curving side wall circumscribing said reservoir and extending up from said floor to said rim.

3. The bowl of claim 2 wherein said rim is substantially circular and said floor is substantially circular.

4. The bowl of claim 2 wherein said rim is oval shaped and said floor is oval shaped.

5. The bowl of claim 1 wherein said at least one side includes a pair of side walls facing each other and a pair of end walls facing each other, said end walls each interposed between said side walls with said end walls and said side walls completely circumscribing said reservoir and with lateral curves between each said side wall and each said end wall.

6. The bowl of claim 1 wherein said predetermined amount of pasta is an amount contained in a package of macaroni and cheese containing uncooked pasta and a cheese packet in amounts suitable for use together in making a macaroni and cheese dish.

7. The bowl of claim 1 wherein said at least one wall extends up from said floor at a taper away from perpendicular to said floor and angled away from a center of said reservoir, said taper having an angle away from vertical of at least 5°.

8. The bowl of claim 7 wherein said taper angle is about 10°.

9. The bowl of claim 8 wherein said taper angle is substantially constant from said water line to said rim.

10. The bowl of claim 9 wherein said water line is located closer to said floor than to said rim.

11. The bowl of claim 1 wherein handles extend laterally from opposite sides of said rim, said handles having a convex top surface, such that water cannot pool on said top surface of said handle.

12. A method for cooking pasta in a microwave oven, including the steps of:
identifying a bowl having a reservoir for holding pasta and water during cooking, the bowl including a floor defining a lower side of the reservoir, the bowl including at least one wall extending up from the floor to a rim opposite the floor, a water line formed in the at least one wall, the water line spaced from the floor and visible to a user and the reservoir having a volume below the water line equal to a volume of combined water and uncooked pasta sufficient to cook a predetermined amount of pasta;
identifying a package having both the predetermined amount of pasta and a flavoring packet sized to flavor the predetermined amount of pasta;
opening the package and placing the pasta into the reservoir;
placing water in the reservoir up to the water line;
placing the bowl with the water and pasta into a microwave oven;
operating the microwave oven for a predetermined amount of time; and
dispensing contents of the flavoring packet into the pasta within the reservoir.

13. The method of claim 12 wherein said identifying a package step includes pasta in the form of macaroni and the flavoring packet in the form of a cheese flavorant.

14. The method of claim 12 including the further step of stirring the contents of the flavoring packet with the pasta.

15. The method of claim 14 including the further step of removing the bowl from the microwave oven by lifting the bowl through the handles.

16. The method of claim 15 including the further step of enjoying the pasta and flavorant directly from the bowl.

17. A method for microwave oven cooking of pasta, including the steps of:
identifying a bowl having a reservoir for holding pasta and water during cooking, the bowl including a floor defining a lower side of the reservoir, the bowl including at least one wall extending up from the floor to a rim opposite the floor, a water line formed in the at least one wall, the water line spaced from the floor and visible to a user and a pasta line formed in the at least one side wall, the pasta line spaced from the floor and visible to a user, the pasta line located below the water line;
placing pasta in the reservoir up to the pasta line;
placing water in the reservoir up to the water line;
locating the bowl in a microwave oven; and
operating the microwave for a predetermined amount of time.

18. The method of claim 17 including the further step of stirring the pasta and water and reheating the pasta and water in the microwave at a break in the predetermined amount of time.

19. The method of claim 18 including the further step of adding a powdered cheese flavorant to the pasta and stirring the powdered cheese flavorant with the pasta.

20. The method of claim 19 wherein the pasta is macaroni and a completed food item produced by the method is macaroni and cheese.
